(19) United States
(12) Patent Application Publication
(10) Pub. No.: US 2013/0168443 A1
(43) Pub. Date: Jul. 4, 2013

(54) COMPUTING DEVICE AND METHOD FOR MONITORING LUGGAGE

(71) Applicant: FIH (Hong Kong) Limited, Kowloon (HK)

(72) Inventor: KAI-YU LIN, Taoyuan (TW)

(73) Assignee: FIH (HONG KONG) LIMITED, Kowloon (HK)

(21) Appl. No.: 13/720,594

(22) Filed: Dec. 19, 2012

(30) Foreign Application Priority Data
Dec. 30, 2011 (TW) 100149931

(51) Int. Cl. G06Q 50/28

(52) U.S. Cl. CPC G06Q 50/28
USPC 235/375

(57) ABSTRACT

A method for monitoring luggage using a computing device. The computing device receives a barcode from a barcode machine connected to the computing device and attaches the barcode the luggage of a passenger when the luggage of the passenger passes through the barcode machine at a first airport when the luggage of the passenger passes through the barcode machine at a first airport when the luggage of the passenger passes through the barcode machine at a first airport. The computing device receives a request from the electronic device of the passenger when the passenger arrives at the second airport. The computing device sends location information of the luggage of the passenger to the electronic device according to the request, and verifies the luggage of the passenger by scanning the barcode using the barcode scanner.

### BACKGROUND

1. Technical Field

Embodiments of the present disclosure relate to monitoring technology, and particularly to a computing device and method for monitoring luggage.

2. Description of Related Art

An airport management system obtains luggage information of passengers and displays the luggage information on a video wall. The luggage information may show where the luggage is located. However, the monitors on the video wall may not show directions to the luggage conveyors. If a passenger is unfamiliar with the layout of the airport, the passenger may take more time to find the luggage conveyors. Thus, there is room for improvement in the art.

### BRIEF DESCRIPTION OF THE DRAWINGS

FIG. 1 is a schematic block diagram of one embodiment of a computing device including a luggage monitoring system.

FIG. 2 is a schematic block diagram of one embodiment of the luggage monitoring system in FIG. 1.

FIG. 3 is a flowchart illustrating one embodiment of a luggage monitoring method.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

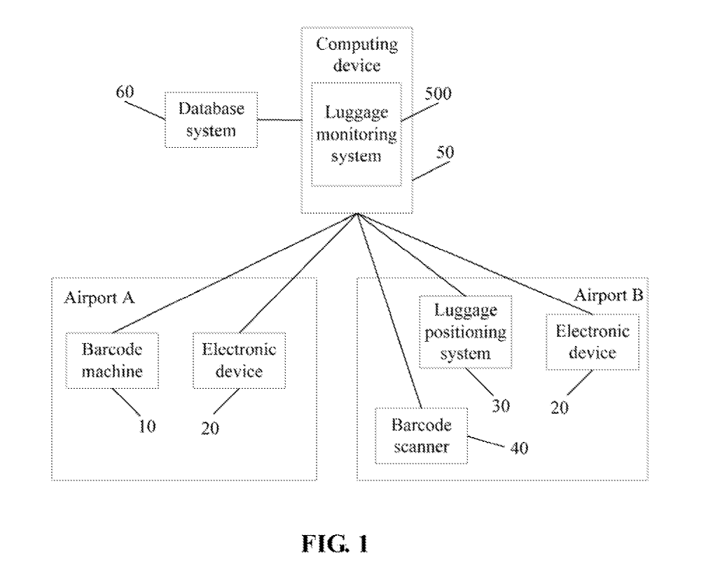

FIG. 1 is a block diagram of one embodiment of a computing device 50 including a luggage monitoring management system 500. In the embodiment, the luggage monitoring system 500 is implemented by the computing device 50. The luggage monitoring system 500 automatically manages the luggage of a passenger. The computing device 50 may be, but is not limited to, a computer, a server, a portable electronic device, or any other electronic device.

The computing device 50 is connected to a barcode machine 10 via a network (e.g., the Internet or a local area network), as shown in FIG. 1. The barcode machine 10 generates a barcode when the luggage passes through the barcode machine 10. The barcode machine 10 also prints the barcode and sticks the barcode on the surface of the luggage. The computing device 50 is also connected to an electronic device 20 via the network and sends the barcode to the electronic device 20. The barcode may be, but is not limited to, a one-dimensional barcode (e.g., EAN, UPC, ITF25, codebar, code93, code128) or a two-dimensional barcode (e.g., PDF417, code49, code 16k, data matxicode). The barcode machine 10 is located at a first airport (e.g., airport A). The first airport is a place where the passenger boards an airplane. The electronic device 20 is carried by the passenger, and is always with the passenger. The electronic device 20 may be, but is not limited to, a mobile phone, a tablet computer, a personal digital assistant (PDA), or any other portable mobile electronic device.

The computing device 50 is further connected to a luggage positioning system 30 and a barcode scanner 40 via the network (e.g., the Internet or a local area network), as shown in FIG. 1. The luggage positioning system 30 and the barcode scanner 40 are located at a second airport (e.g., airport B). When the passenger arrives at the second airport, he just checks his/her electronic device 20 and knows where to go for his luggage. The second airport is the destination where the passenger arrives. The luggage positioning system 30 provides location information of the luggage at the second airport. In one embodiment, the luggage positioning system 30 includes an electronic map of the second airport. The luggage positioning system 30 generates the location information of the luggage and shows the location information of the luggage in the electronic map of the second airport, if the luggage positioning system 30 reads the barcode which is attached to the luggage using the barcode scanner 40. The barcode scanner 40 may be, but is not limited to, a pen-type scanner, a laser scanner, a charge coupled device (CCD) scanner, or a camera-based scanner.

The electronic device 20 provides an operation interface for taking one or more operations of the computing device 50. For example, the user may input a username and a password in the operation interface and login in the luggage monitoring system 500 of the computing device 50, then the user uses the electronic device 20 to login the computing device 50.

The computing device 50 is also connected to the database system 60 using database connectivity interfaces, such as open database connectivity (ODBC) or java database connectivity (JDBC). The database system 60 may store location information of the luggage, the electronic map of the airport, and the barcode.

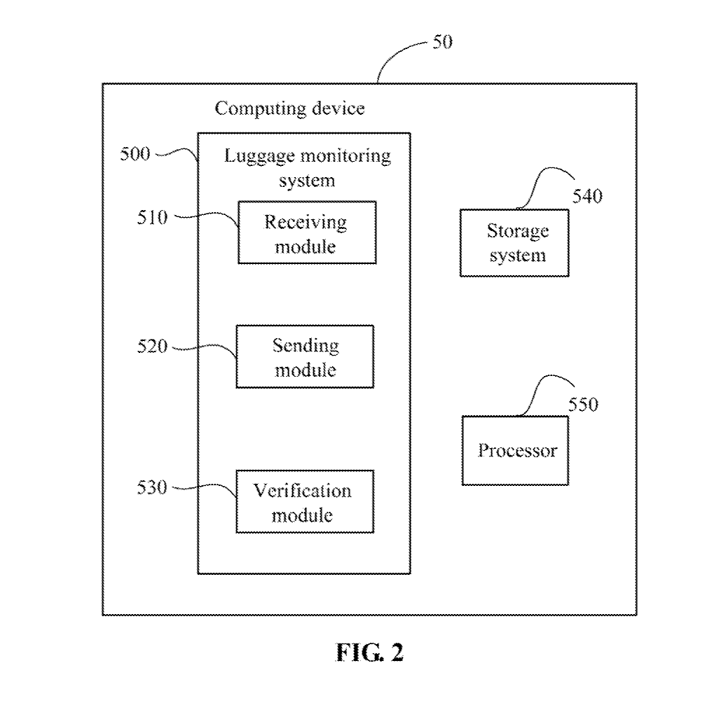

FIG. 2 is a block diagram of one embodiment of the luggage monitoring system 500. In one embodiment, the luggage monitoring system 500 includes a receiving module 510, a sending module 520, and a verification module 530. The modules 510-530 may include computerized code in the form of one or more programs that are stored in a storage system 540 of the computing device 50. The computerized code includes instructions that are executed by the at least one processor 550 of the computing device 50 to provide functions for modules 510-530. The storage system 540 may be a memory chip, a hard disk drive, or a flash memory stick.

The receiving module 510 receives a barcode from the barcode machine 10 when the luggage passes through the barcode machine 10 at the first airport. As mentioned above, when the luggage passes through the barcode machine 10 at the first airport, the barcode machine 10 generates the barcode corresponding to the luggage.

The sending module 520 sends the received barcode to the electronic device 20. The sending module 520 wirelessly sends the received barcode immediately to the electronic device 20 when the passenger holds the electronic device 20 at the first airport.

The receiving module 510 further receives a request from the electronic device 20 when the passenger arrives at the second airport. The request requires the computing device 50 to collect location information of the luggage from the luggage positioning system 30, and further to send the location information of the luggage to the electronic device 20. The location information of the luggage includes position description (e.g., near exit 5 of the second airport), an icon (e.g., a red pin) on the electronic map of the second airport to show where the luggage is, and a telephone number of an office which is in charge of managing the luggage at the second airport.

The sending module 520 sends the location information of the luggage to the electronic device 20 according to the request. The location information of the luggage is displayed in a display of the electronic device 20, and directs the passenger to the location of the luggage.

The verification module 530 verifies the luggage using the barcode scanner 40 to scan the barcode in the electronic device 20 and the barcode sticking on the surface of the luggage. In one embodiment, the staff at the second airport uses the barcode scanner 40 to verify the luggage, if the barcode in the electronic device 20 is the same as the barcode attached to the luggage, the luggage is determined to belong to the passenger who holds the electronic device 20, the passenger can take away the luggage.

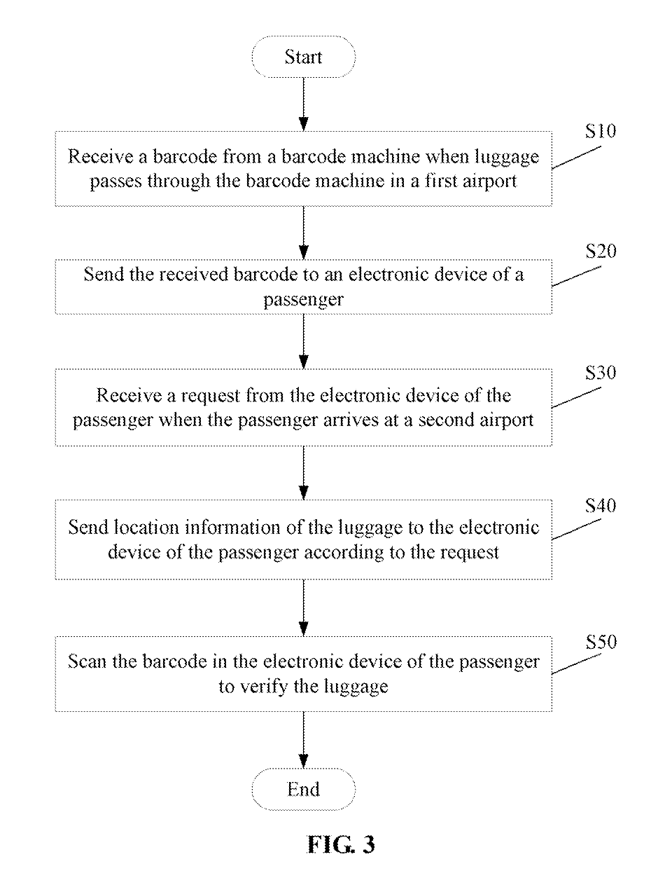

FIG. 3 is a flowchart of one embodiment of a luggage monitoring method. Depending on the embodiment, additional steps may be added, others deleted, and the ordering of the steps may be changed.

In step S10, the receiving module 510 receives a barcode from the barcode machine 10 when the luggage passes through the barcode machine 10 at the first airport. As mentioned above, the barcode machine 10 generates the barcode corresponding to the luggage and wirelessly sends the barcode to the computing device 50.

In step S20, the sending module 520 wirelessly sends the received barcode to the electronic device 20.

In step S30, the receiving module 510 further receives a request from the electronic device 20 when the passenger arrives at the second airport. The passenger logins to the luggage monitoring system 500 using the electronic device 20 and sends the request to the luggage monitoring system 500. Additionally, the receiving module 510 also receives information from the luggage positioning system 30 and further checks that the luggage did arrive at airport B when the passenger arrive at the airport B.

In step S40, the sending module 520 sends the location information of the luggage to the electronic device 20 according to the request. The passenger can easily find the location of the luggage according to the location information of the luggage.

In step S50, the verification module 530 verifies the luggage using the barcode scanner 40 to scan the barcode in the electronic device 20 and the barcode sticking on the surface of the luggage. As mentioned above, the staff at the second airport uses the barcode scanner 40 to verify the luggage at the second airport, if the barcode in the electronic device 20 is the same as the barcode sticking on the surface of the luggage, the luggage is determined to belong to the passenger who holds the electronic device 20.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
a storage system;
at least one processor; and
one or more programs stored in the storage system and being executable by the at least one processor, the one or more programs comprising:
a receiving module receives a barcode from a barcode machine connected to the computing device and attaches the barcode to the luggage of a passenger when the luggage of the passenger passes through the barcode machine at a first airport;
a sending module sends the received barcode to an electronic device of the passenger;
the receiving module further receives a request from the electronic device of the passenger when the passenger arrives at a second airport;
the sending module further sends location information of the luggage of the passenger to the electronic device according to the request, wherein the location information of the luggage of the passenger directs the passenger to a location of the luggage at the second airport; and
a verification module verifies the luggage of the passenger by scanning the barcode using a barcode scanner.

2. The computing device of claim 1, wherein the location information of the luggage of the passenger comprises a position description, an icon on an electronic map of the second airport to show where the luggage is, and a telephone number of an office which is in charge of managing the luggage at the second airport.

3. The computing device of claim 1, wherein the barcode scanner is selected from the group consisting of a pen-type scanner, a laser scanner, a charge coupled device (CCD) scanner, and a camera-based scanner.

4. The computing device of claim 1, wherein the barcode is a one-dimensional barcode or a two-dimensional barcode.

5. The computing device of claim 1, wherein the electronic device is selected from the group consisting of a mobile phone, a personal digital assistant (PDA), a handheld game player, a digital camera and a tablet computer.

6. A computer-based luggage monitoring method, the method comprising:
receiving a barcode from a barcode machine connected to the computing device and attaches the barcode to the luggage of a passenger when the luggage of the passenger passes through the barcode machine at a first airport when the luggage of the passenger passes through the barcode machine at a first airport;
sending the received barcode to an electronic device of the passenger;
receiving a request from the electronic device of the passenger when the passenger arrives at a second airport;
sending location information of the luggage of the passenger to the electronic device according to the request, wherein the location information of the luggage of the passenger directs the passenger to a location of the luggage at the second airport; and
verifying the luggage of the passenger by scanning the barcode using a barcode scanner.

7. The method of claim 6, wherein the location information of the luggage of the passenger comprises a position description, an icon on an electronic map of the second airport to show where the luggage is, and a telephone number of an office which is in charge of managing the luggage at the second airport.

8. The method of claim 6, wherein the barcode scanner is selected from the group consisting of a pen-type scanner, a laser scanner, a charge coupled device (CCD) scanner, and a camera-based scanner.

9. The method of claim 6, wherein the barcode is a one-dimensional barcode or a two-dimensional barcode.

10. The method of claim 6, wherein the electronic device is selected from the group consisting of a mobile phone, a personal digital assistant (PDA), a handheld game player, a digital camera and a tablet computer.

11. A non-transitory computer-readable medium having stored thereon instructions that, when executed by a computing device, causing the computing device to perform a luggage monitoring method, the method comprising:
receiving a barcode from a barcode machine connected to the computing device and attaches the barcode to the luggage of a passenger when the luggage of the passenger passes through the barcode machine at a first airport when the luggage of the passenger passes through the barcode machine at a first airport;
sending the received barcode to an electronic device of the passenger;
receiving a request from the electronic device of the passenger when the passenger arrives at a second airport;
sending location information of the luggage of the passenger to the electronic device according to the request, wherein the location information of the luggage of the passenger directs the passenger to a location of the luggage at the second airport; and
verifying the luggage of the passenger by scanning the barcode using a barcode scanner.

12. The non-transitory computer-readable medium of claim 11, wherein the location information of the luggage of the passenger comprises a position description, an icon on an electronic map of the second airport to show where the luggage is, and a telephone number of an office which is in charge of managing the luggage at the second airport.

13. The non-transitory computer-readable medium of claim 11, wherein the barcode scanner is selected from the group consisting of a pen-type scanner, a laser scanner, a charge coupled device (CCD) scanner, and a camera-based scanner.

14. The non-transitory computer-readable medium of claim 11, wherein the barcode is a one-dimensional barcode or a two-dimensional barcode.

15. The non-transitory computer-readable medium of claim 11, wherein the electronic device is selected from the group consisting of a mobile phone, a personal digital assistant (PDA), a handheld game player, a digital camera and a tablet computer.
